(19) United States
(12) Patent Application Publication
(10) Pub. No.: US 2012/0183667 A1
(43) Pub. Date: Jul. 19, 2012

(54) PARTICULATE FROZEN YOGURT-BASED PRODUCT

(75) Inventors: Stan Jones, Vienna, IL (US); Curt Jones, Brentwood, TN (US); Kay Jones, Brentwood, TN (US); Robert Lynn, Nashville, TN (US)

(73) Assignee: Dippin' Dots, Inc., Paducah, KY (US)

(21) Appl. No.: 13/185,868

(22) Filed: Jul. 19, 2011

Related U.S. Application Data
(63) Continuation-in-part of application No. 11/801,049, filed on May 8, 2007.
Application No. 11/801,049 is a continuation-in-part of application No. 11/701,624, filed on Feb. 2, 2007, now abandoned.
(60) Provisional application No. 61/400,056, filed on Jul. 22, 2010.
(60) Provisional application No. 60/874,055, filed on Dec. 11, 2006.

(51) Int. Cl. A23G 9/40; A23L 2/38; A23G 9/44

(52) U.S. Cl. 426/583; 426/442; 62/62

(57) ABSTRACT

In accordance with a preferred embodiment, there is provided a frozen yogurt product that remains frozen at relatively high temperatures and can be added to juice, milk, or other liquid to create a smoothie or similar beverage.

### CROSS-REFERENCE TO RELATED APPLICATIONS

This application is a Continuation-in-Part of U.S. application Ser. No. 11/801,049 filed May 8, 2007 which is Continuation-in-Part of U.S. application Ser. No. 11/701,624, which was filed on Feb. 2, 2007, which in turn claims priority to U.S. Provisional Application No. 60/874,055, which was filed on Dec. 11, 2006. Priority is claimed to each of these patent applications and their disclosures are incorporated by reference in their entirety.

### FIELD OF THE INVENTION

The present invention relates to particulate frozen food product or frozen confection, and in preferred embodiments to particulate yogurt-based products capable of being stored within commercial dairy freezers and storage equipment at conventional freezer temperatures.

### BACKGROUND OF THE INVENTION

Recent developments in cryogenics have enabled the manufacture of ice cream-type food products in particulate form using cryogenic equipment. Storing particulate ice cream-type products made using cryogenic techniques usually requires that specialized equipment such as very low temperature freezers, be used for storage and in the retail environment. This is because some particulate products require storage temperatures at or below −35° F. to maintain their free-flowing particulate properties. Such specialized equipment is not present in most food retail establishments, schools, and homes, such that a particulate food product which can be stored in typical retail dairy case and home storage environments is desired.

### SUMMARY OF THE INVENTION

In accordance with a preferred embodiment, there is provided a frozen yogurt product that remains frozen at relatively high temperatures and can be added to juice, milk, or other liquid to create a smoothie or similar beverage.

In accordance with another embodiment, there is provided a method of manufacturing a frozen food product, comprising preparing a formulation, including one as described above, wherein the formulation is preferably made by combining liquid ingredients, combining dry powders, and mixing the combined dry powders with the combined liquids to make the formulation, and where the method continues by agitating the formulation, pasteurizing the formulation, homogenizing the formulation, aging the formulation, and dripping the formulation into a cryogenic processor to form a particulate frozen food product. In a preferred embodiment, the homogenizing step acts to synchronize the pasteurizing step.

In accordance with another embodiment, there is provided a method of retailing a frozen product, comprising manufacturing a frozen product, including one as described above, shipping the frozen product to a plurality of staging areas, during the shipping step, maintaining the frozen product at a predetermined temperature range, thereby preserving the free-flowing nature of the frozen product, staging the frozen product in strategic storage locations, crossing the frozen product over an international border, shipping the frozen product to a plurality of retail areas, and retailing the frozen product. In a preferred embodiment, the method also includes packaging the frozen product, using gas- or moisture-barrier plastics.

### BRIEF DESCRIPTION OF THE DRAWINGS

FIG. 1 is a flowchart showing details of a preferred embodiment;

FIGS. 2A-2C show distribution mechanisms according to a preferred embodiment;

FIG. 3 shows an equipment arrangement of a preferred embodiment;

FIG. 4 is a cross-sectional elevational view of an apparatus used within a preferred embodiment;

FIG. 5 depicts embodiments of pellets in accordance with the principles of the present invention.

### DETAILED DESCRIPTION OF THE PREFERRED EMBODIMENTS

### A. Definitions and General Descriptions

Before explaining the disclosed embodiments in detail, it is to be understood that the invention is not limited in its application to the details of the particular arrangement or formulations shown. Also, the terminology used herein is for the purpose of description and not of limitation.

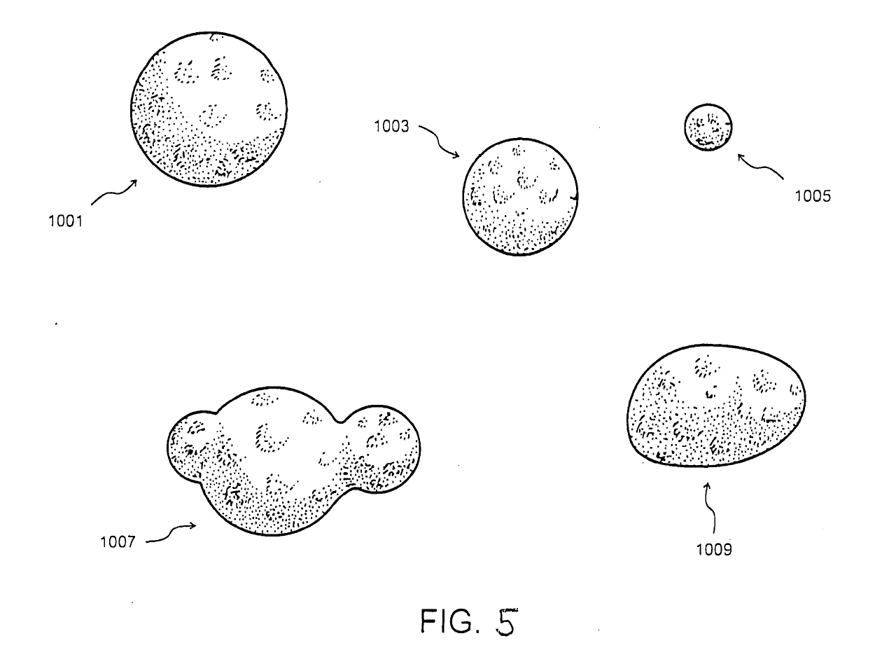

In accordance with preferred embodiments, there are provided formulations of frozen confections, such as ice cream, ice milk, ices, or sorbet, in the form of small particulate shapes. One particular product in preferred embodiments of the present invention is based on a yogurt-based mixture. The particulate shapes may have a generally spherical, spheroid shape, but may also have an oblong, elliptical, oblate, tubular, or other slightly irregular shape as shown in FIG. 5. In addition to having an irregular overall shape, the surface of the particulate shape may also be either smooth or irregular (e.g. bumpy, pocked, etc.). On average, the particulate shapes will preferably have a diameter of about 0.05 inch to about 0.5 inch or less, including 0.4 inch, 0.3 inch, 0.25 inch, 0.2 inch, 0.15 inch, and about 0.1 inch, and ranges including and bordered by these dimensions. Particulate shapes having diameters outside these ranges are also contemplated. For non-spherical shapes which do not have a conventional diameter, the diameter is to be the diameter of the smallest sphere into which the particulate shape would fit.

Frozen yogurt is a food that is typically prepared by freezing a pasteurized mix containing milkfat, nonfat milk solids, sweetener, stabilizer, yogurt and water. It may contain any numerous flavoring agents such as, for example, fruits. The yogurt ingredient may be cultured with a mixture of Lactobacillus bulgaricus and Streptococcus thermophilus bacteria after the milk has been pasteurized. In some embodiments, a very high heat treatment (e.g., 185 degrees F., for 15 minutes) can be given to the milk before it is inoculated with the yogurt culture. The amount of yogurt ingredient added to the mix affects the mix's acidity but can typically range from about 0.1% to about 1% of the total weight of the mix. However, the amount of yogurt ingredient can be adjusted depending on the acidity level desired for the mix or based on how long the acidity is allowed to developed before further processing occurs with the mix. For example, non-frozen yogurt product have an acidity level of about 4 pH; the present frozen product can have this pH level as well or a somewhat different level depending on the attributes desired for the frozen product. Also, it may be desirable in some formulations to minimize the amount of acetaldehyde flavor in the frozen yogurt which some consumers find has a disagreeable taste. Frozen yogurt products are relatively low in fat content when compared to ice cream with the highest fat content of typical frozen yogurt products being near 4%.

It is desired that the beaded product is in a free-flowing format so that it is readily pourable. Free-flowing, as used herein, is a broad term which includes the ability of the product to flow as individual particulate shapes, with little or no clumping or sticking to each other, during such pouring. There may be slight sticking after a period of storage, but a light tap on the container will unstick the particulate shapes and allow them to be free flowing. The generally spherical shape helps contribute to the free-flowing, pourable product.

Some types of particulate shapes are stored in a specialized, low temperature freezer preferably having a temperature averaging from about −20° F. to about −40° F. In preferred embodiments, particulate shapes that can be stored at higher temperatures, such as in a home freezer or in a grocery dairy freezer are provided, such particulate shapes being able to maintain a free-flowing form while being stored at a temperature between about −10° F. and 0° F. with an occasional rise to perhaps as much as +5° F. One way to accomplish this is to increase the freezing point (reduce the freeze-point depression) of the liquid formulation that forms the particulate shapes, although other ways may also be used. Unless stated otherwise, all percentages recited in this application are percentages by weight of the formulation.

### B. Ingredients and Formulations According to Certain Preferred Embodiments

As stated, it is desired to store the particulate shapes within a conventional freezer and yet still maintain their free-flowing properties. To achieve this, various sample liquid formulations used in making the particulate shapes will now be described. It should be noted that the formulations described below are only examples, and numerous other formulations containing various amounts of ingredients as described herein may be made. Although particular formulations are given, the general guidelines in formulating a product mix is to keep the total solids to about 30% or less, keeps added sugar to about 4% or less, and to rely on bulk fillers such as whey and maltodextrins. Maltodextrins have an effect on the freeze point of the resulting product such that it is beneficial to use maltodextrins that use a sweetness index of 10 or below.

In practice, the amount of yogurt and flavor in the frozen product can be formulated so that it can be combined in one-to-one ratio with a liquid such as milk, juice, or water to form a smooth, cold beverage (e.g., smoothie) without a blender or ice. Thus, simply using a spoon or shaking the liquid and frozen pellets, a beverage can be created similar to a yogurt smoothie in a simple and efficient manner.

Some of the components of three different example formulation types are as follows (all percentages are by weight of the total formulation):

| Ingredient | Formulation I | Formulation II | Formulation III |
|---|---|---|---|
| Milk fat (butterfat) | 9-11% | 6-14% | |
| Non-fat milk solids | 4-12% | 4-20% | |
| Maltodextrins (or other | 0-20% | 0-20% | 0-10% |
| bulking agent) | | | |
| Sugar | 15-17% | 2.6-8% | 2-10% |
| sweetener (artificial) | | <0.4% | <0.8% |
| combined | <1% | <4% | <1% |
| stabilizer/emulsifier | (if present) | (if present) | (stabilizer |
| | | | only) |
| total solids | >=35.5% | >=29.7% | |
| Water | <=63.5% | <=70.3% | 70-96% |

The freezing point of the various formulations disclosed herein which form the particulate shapes can be increased by making adjustments to one or more of the above components, and some adjustments work better in combination with each other. As shown above, some of the formulations above comprise various total solids combined with water. Within the particulate shapes, water is present both as a liquid and as a solid. This is because not all water freezes, due to the presence of dissolved solutes and the cryogenic freezing itself. The solid/liquid ratio within the particulate shapes affects their firmness. This in turn affects pourability and the ability of the particulate shapes to remain free-flowing. Other factors may affect the pourability, including, but not limited to, size of the ice crystals, freezing point, melting point, glass transition temperature, presence or absence of devitrification, storage temperature and conditions. These factors will be discussed further in Section C below.

One component of the solids of dairy formulations such as those according to Formulae I and II is milkfat. The milkfat, also called butterfat, in the composition provides much of the creamy texture and body to the formulation, with higher levels providing greater creaminess and richness.

Serum solids or nonfat milk solids are those components of milk and/or cream which are water soluble, including but not limited to caseins and other milk proteins. It is to be noted that although milkfat and water are listed as separate ingredients, milkfat, water and serum solids are, in most embodiments, included in the milks and creams that form the basis of the dairy Formulations I and II, and thus do not necessarily comprise separate ingredients.

Nonfat milk solids enhance the texture of frozen products, aid in giving body and chew resistance, and may be less expensive than milkfat. Whey solids, including modified whey products, may also be substituted for nonfat milk solids. Egg yolk can also be used as another source of solids. Accordingly, in one embodiment, preferably about 1% to 25%, including 5% to 20% and 10% to 15% of the nonfat milk solids in a formulation comprise whey solids and/or egg yolk solids.

Emulsifiers can also be included within the various formulations, especially those containing milkfat. Preferred emulsifiers can include monoglycerides, diglycerides, and polysorbates. Stabilizers may be included within the various formulations. Stabilizers assist in controlling the viscosity of the formulations, with more stabilizer generally providing increased viscosity, especially in those embodiments having lower amounts of fats and solids. The viscosity affects the drip rate of the formulation while it is formed. Within the dairy Formulations I and II, preferred stabilizers can include guar, carrageenan, LBG, and/or CMC. Within the non-dairy Formulation III, a preferred stabilizer can include cellulose gum.

In those dairy embodiments where both stabilizers and emulsifiers are used, the formulations disclosed herein for making the frozen confection includes a combined stabilizer/emulsifier, and the recited amounts are the combined total of the stabilizer and emulsifier present. The combined stabilizer/emulsifier need not actually be added as a single ingredient when making the formulation; the weights of these two materials are included together because in many embodiments, commercial combined stabilizer/emulsifier formulations are used, which include one or more stabilizers and one or more emulsifiers. Accordingly, the stabilizer/emulsifier may be a commercial or proprietary formulation or it may be a combination or series of one or more stabilizers and/or one or more emulsifiers added to the formulation.

One or more bulking agents may also be added to formulations according to certain embodiments. Bulking agents include polymeric compounds (such as polysaccharides), which add viscosity and bulk to foods. Preferred bulking agents include, but are not limited to polydextrose, dextrans, corn syrup solids, and maltodextrins. In certain preferred embodiments, maltodextrins are used. In a preferred embodiment, the total amount of bulking agents is 1% to 20% by weight, including 1%-15% by weight, 5%-15% by weight, including 6%, 8%, 10% and 12% by weight. Because bulking agents and stabilizers both contribute to the viscosity of a formulation, formulations containing a bulking agent may or may not include a stabilizer or stabilizer/emulsifier.

Formulations preferably include at least some sugar (sucrose). Sucrose is preferably present at around 4% or below. Formulations generally also include some lactose, as it is a natural part of milk, cream, and nonfat milk solids. In a preferred embodiment, the lactose in the formulation is at 2-15% by weight. Formulations may include other non-sugar sweeteners in the formulation such as fructose, sugar alcohols also known as polyols, such as erythritol, xylitol, and maltitol, artificial sweeteners including, but not limited to, sucralose, aspartame, and saccharine, and combinations of one or more sweeteners. One particular sweetener that can be used is the all natural sweetener Rebiana. Because sweeteners are much sweeter than sugar for a given weight, for example, sucralose is about 600 times sweeter than sugar, the amount of sucralose can be very small (e.g. 0.01-0.4% by weight, if present, including about 0.015, 0.02, 0.03, 0.04, 0.05, 0.1, 0.15, 0.2, 0.3 and ranges encompassing and bounded by these values) yet still have effective sweetness. Accordingly, the substitution of sweeteners for sugar can reduce the amount of solids and sucrose in the formulation.

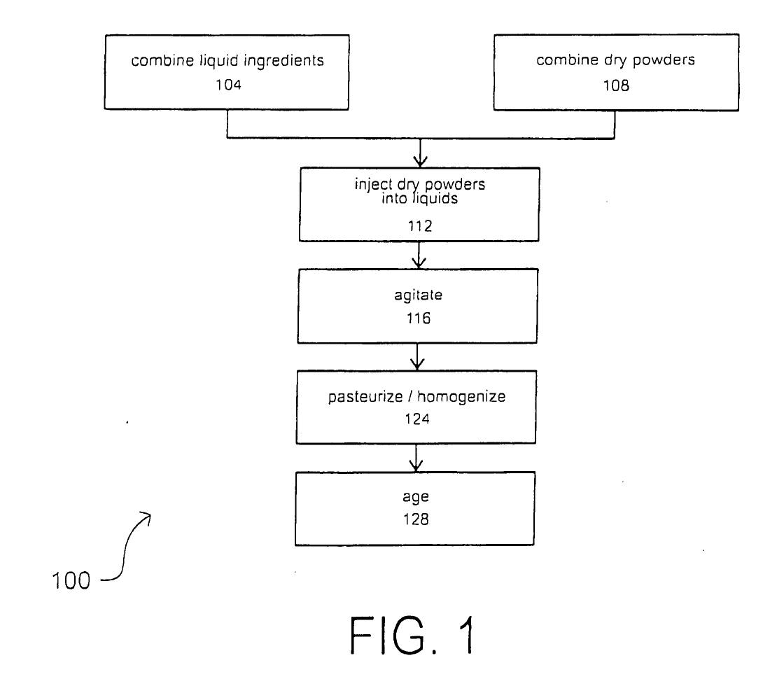

Of the artificial sweeteners, sucralose has an advantage of remaining stable during homogenization/pasteurization (step 124 of FIG. 1). Sucralose is not used to give bulk volume to the resulting formulation, as doing so would make the resulting formulation excessively sweet. Other non-sugar sweeteners have some similar properties as well.

The formulations also include one or more flavorings. These include but are not limited to chocolate, strawberry, vanilla, and banana split. The amount of flavoring added is usually somewhat small, such that differences in composition are relatively minute such that the flavoring does not substantially affect the storability characteristics of the particulate shapes formed from the various formulations.

It should be noted, however, that some flavorings, such as the chocolate generally require the presence of additional sweeteners over what is necessary for other flavorings (e.g. vanilla). In the case of chocolate, additional sugar or sweetener such as corn syrup solids or other sweetener are preferably added in excess of the amount that would be present normally to provide additional sweetness that is of benefit with the cocoa powder added for flavoring at a level, in preferred embodiments, of about 0.5%-2%, including about 1% and 1.5%.

As shown above, a variety of formulations are available which fall within the parameters disclosed herein. However, within all formulations including a solids component (generally the dairy-based formulations) the total solids percentage plus water percentage will equal 100. Thus, for example, if the total solids content of a formulation rises, it is to be understood that the water content is reduced accordingly.

Stabilizing agents are also used to give texture, body, stiffness and alter the melting properties of the ice products described herein. These are especially important in particulate ice product, because forming the particulate shapes in a spherical or similar shape and the resulting free-flowing properties generated therefrom are beneficial to the commercial success of the product. The stabilizers accomplish this by binding up water that has melted due to temperature fluctuations, and thus preventing that water from diffusing throughout the entire formulation and forming larger ice crystals upon refreezing.

As noted before, particulate frozen yogurt products are generally stored at very low temperatures in cryogenic freezers. In certain preferred embodiments, the product is capable of being stored at higher temperatures, such as in a freezer at temperatures that are commonly used to store conventional ice cream and frozen foods while maintaining the properties of the particulate shapes being substantially free-flowing and pourable. Accordingly, in a preferred embodiment, a formulation of beaded product is substantially free flowing when stored at a temperature between −10° F. and 10° F., including −5° F. and 0° F. with or without including an occasional rise to perhaps as much as +5° F., such product being stored for a period of time of about four months, including about three months, about two months and about one month. Such temperature conditions of storage at 0° F. with a periodic rise to about +5° F. are commonly found in self-defrosting commercial freezers at retail establishments where products, such as frozen confections may be sold. Maintenance of the free-flowing nature of the particulate shapes is highly desired because it has important commercial significance.

Several factors and properties can affect the stability and performance of formulations suitable for storage at higher temperatures. One property is the freezing point of the formulation. Formulations having a higher freezing point are able to remain more firmly frozen at higher freezer temperatures, which contributes positively to the product remaining free-flowing. One way to increase the freeze point of a formulation is to decrease the amount of low molecular weight compounds with or without modifying the total solids of the formulation.

In a preferred embodiment, a formulation has a freezing point of at least 27° F., including at least about 27.5° F., at least about 28° F., at least about 28.5° F., at least about 29° F., at least about 29.5° F., at least about 30° F., at least about 30.5° F., at least about 31° F., and at least about 31.5° F. In a preferred embodiment, the freezing point is between 29° F. and 31° F.

In embodiments having a higher storage temperature partly because of a reduction in solids, one way of improving the palatability of the product is to increase the amount of non-fat milk solids. Non-fat milk solids improve body, texture, and most importantly taste of the resulting particulate shapes.

One way of reducing the solids is to replace sucrose in the formulation with an artificial or natural sweetener that provides high sweetening power but donates much less solids that would contribute to an undesirable depression of the freezing point. It has been found, however, that there is a benefit in retaining some sucrose in a formulation, because it is useful as a body enhancer and shelf life extender, thereby keeping the artificial sweeteners from going flat in taste over time.

Because sugars like sucrose and lactose or small saccharides (e.g. disaccharides) contribute very strongly to freezing point depression, in certain embodiments, the amount of such small saccharides is reduced or minimized. Strategies for reducing the amount of sucrose include substituting other non-sugar or sweeteners. Strategies for reducing the amount of lactose include using reduced-lactose milk, cream and/or alternative nonfat milk solids, and/or using less of one or more of these ingredients. In a preferred embodiment, the total amount of disaccharides in a formulation is preferably 20% by weight or less. The solids content of the formulation can be maintained by replacing some or all of the eliminated monosaccharides and/or disaccharides with other compounds, for example, bulking agents and other milk solids.

Although not wishing to be bound by theory, it is believed that one of the factors that contributes to sticking of the particles is the amount of free (non-crystalline) water present in the formulation. That is, if two formulations having equal amounts of total water but different proportions of ice to free water (due to differences in formulation) are stored in identical conditions, it is postulated that the formulation having the higher percentage of free water will tend to have particles that stick together more (and sooner) than the formulation having more of its water bound up in crystals as ice. Accordingly, in a preferred embodiment, preferably 0.1% to 16% of the water in a formulation is present as free water at 0° F.

The amount of free water in a formulation at a given temperature depends upon the temperature of the onset of melting. Therefore, in certain preferred embodiments, the temperature at which the melting of a frozen formulation begins (onset of melting) is preferably about −31° F. or higher.

Other properties that affect the properties of the product at higher temperatures are the glass transition and devitrification temperatures of the product formulation. Initially when the beaded product is formed, it is flash frozen such that the product is a food glass in which the molecules of the formulation are in an arrested state of motion such that they cannot organize into a crystalline structure even though the formulation is at a temperature well below the freezing point. This glassy form is characterized by the molecules being disordered and the material is brittle and somewhat unstable. As this material is warmed, it surpasses or goes through its glass transition. This occurs at a temperature preferably around −40° F. (+/− about 5° F.). At the glass transition temperature, molecules in the formulation begin to break free such that the material transitions from the glassy state into a material that is rubbery or plasticized.

If the material is allowed to continue to warm to a slightly higher temperature, it will eventually reach the temperature at which devitrification might occur. Devitrification is the process of ice formation during heating. With regard to devitrification and ice crystal formation, there are several considerations. Two considerations are the temperature at which devitrification occurs and the magnitude of the exotherm during ice formation.

Regarding glass transition, the use of maltodextrins or other bulking agents in Formulations I and II and other formulations disclosed herein can be beneficial during the transition from the glass to the rubbery state. This is because maltodextrins inhibit the mobility of unbound (free) water. The less free water there is available to move around, the harder it is for free water to form ice crystals and/or promote product stickiness. Instead, the maltodextrins or other bulking agents help to constrain the free water so that crystal formation is more difficult.

Recrystallization is the process of changes in number, size and shape of ice crystals during frozen storage, although the amount of ice stays constant with constant temperature throughout this process. Recrystallization basically involves small crystals disappearing, large crystals growing, and crystals fusing together.

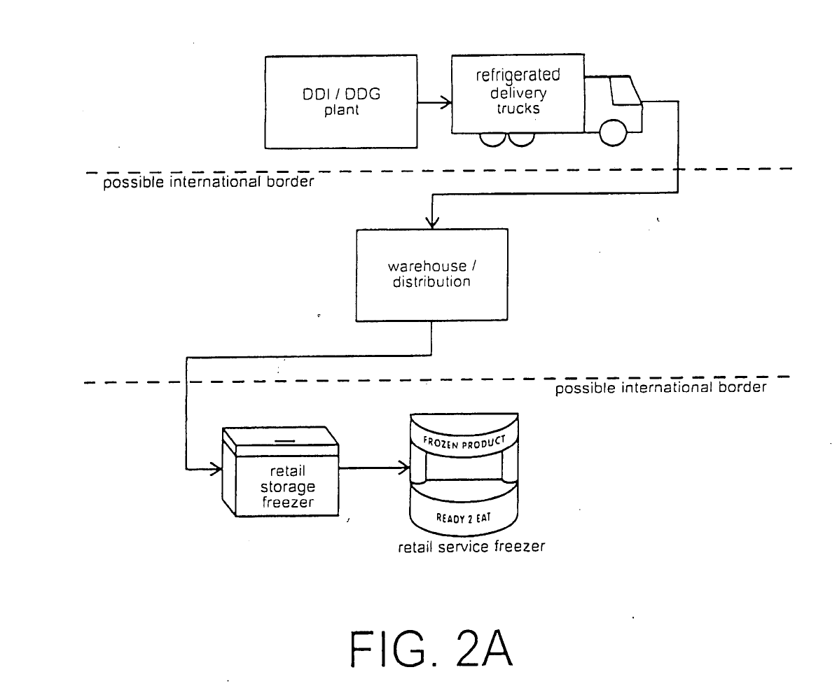

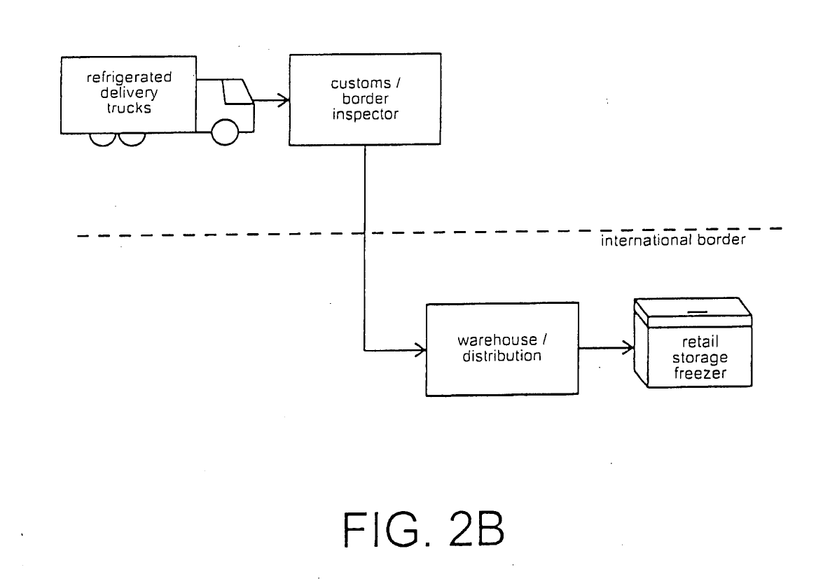

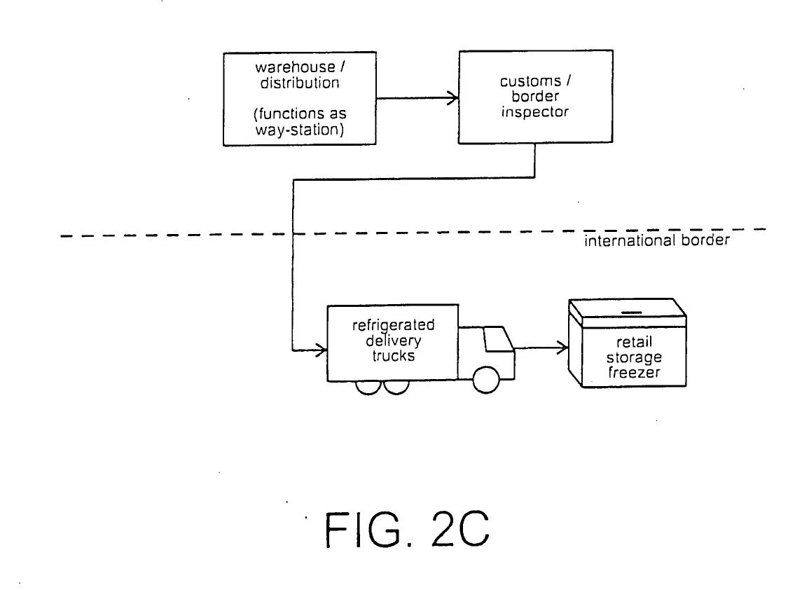

Recrystallization occurs during higher storage temperatures (heat shock) that induce refreezing. Such heat shock could occur during the transporting and storage of the particulate shapes, including during the inspection process which is necessary at international borders for example, as shown in FIGS. 2A-C. Recrystallization is undesirable because it can lead to disappearance of smaller crystals during warming, and growth of larger crystals during later freezing. Smaller crystals are more subject to melting. Thus, even if the products have smaller ice crystals at formation, it is preferable to make them more able to withstand temperature changes during shipping and storage. One way to do this is be careful management of the product during shipping, as shown in FIGS. 2A-C.

Another way to preserve small crystal size and maintain the product during shipping and storage is to include cryoprotectant, including but not limited to ice structure proteins and propylene glycol monostearate, in the formulation. These materials are optionally included in a formulation at about 0.1% to 5% by weight, including 0.1% to 1%, 0.2%-0.6%, and 0.2%-0.4%.

Therefore, although a formulation having the highest freeze point might be considered to have the highest storage temperature, this is not necessarily the case. This is because there are many factors that affect storage stability, such as glass transition, presence or absence of devitrification, amount of free water present at the storage temperature, and/or onset of melting for any given formulation.

Several different properties of formulations have been discussed above in this section. Formulations according to preferred embodiments preferably have at least one of the preferred properties discussed above. It is not required that any or all formulations possess all preferred properties. Preferred properties of a product may vary depending upon any number of variables, including but not limited to the shipping conditions, storage conditions, average time between production and consumption, country of sale, and the like with respect to a given product. The skilled artisan balances the various physical properties and characteristics of a formulation, along with the very important property of taste, to create a formulation that he feels best meets the needs and constraints placed upon the product by virtue of its production, storage, handling, and use. Such formulations may maximize some properties and/or minimize others as part of the trade-offs that are frequently part of the art of formulating a product.

A variety of packaging options may be used to maintain the beaded product in optimum condition after formation. At the higher freezer temperatures (such as 0° F.), moisture is attracted to the product which forms undesirable ice crystals on the product after about 7 days, depending on various conditions. Therefore, it is desired to package the product using materials that will prevent moisture from migrating through to the particulate shapes. Some plastics will allow moisture to penetrate into the package, so it is desired to avoid these. Instead, gas- or moisture-barrier plastics may be used for packaging the particulate shapes. Also, aluminum foil may also be used alone or in combination with plastic and/or paper layers. Other materials are also contemplated within the spirit and scope of this disclosure.

### C. Preferred Apparatus and Methods of Manufacture

The product described above may be manufactured in any suitable apparatus and using any suitable method. Accordingly, the methods and apparatus described in this section are merely examples. In a preferred embodiment, a particulate frozen yogurt product is manufactured in a process 100 as shown in FIG. 1. The liquid and dry ingredients are separately combined (steps 104, 108), and then the dry materials are injected into the liquid materials (step 112). From that point onward until the dripping step, the formulation is preferably continually agitated (step 116) except for when it is inside the pasteurizer/homogenizer (step 124). The formulation is then stored in an ageing vat (step 128).

Referring to FIG. 2A, one preferred formulation can result in products which are kept at −40° F. for periods of up to two years, although the storage time prior to consumption is usually much shorter. For other formulations, for example, the products are preferably stored at about −30° F. or below for long time storage, and about −20° F. for warehouse distribution. The products made from certain preferred formulations discussed herein remain free-flowing, as defined hereinabove, when stored in a freezer at 0° F. for at least 10 days, at least 20 days, at least 30 days, at least 40 days, or longer. Storage in a freezer at 0° F. includes storage in an automatically defrosting freezer at 0° F. inclusive of a defrosting cycle that includes periodic rises in temperature to about 5° F. for defrosting, for example, about three times each 24 hour period. For such embodiments, the performance of the product is enhanced when the temperature thresholds of the various storage mechanisms shown within FIG. 2A are complied with. Temperatures above these thresholds could result in heat shock, devitrification, and other unwanted effects that would cause the particulate shapes to have a higher stickiness and result in a loss of some or all of the free-flowing character.

FIGS. 2B and 2C address the issue of the products being transported across international borders, therefore requiring inspection. FIG. 2B illustrates a situation in which the product arrives at the border inspection station in a refrigerated delivery truck. Because it is beneficial to avoid subjecting the various products to heat shock, careful precautions are suitable. One such precaution includes a way-station as shown in FIG. 2C, which super-freezes the product such that it can withstand the minimal amount of heat-shock that is an unavoidable part of an inspection process, and yet not enter into a glass-transition phase. In FIG. 2C a specific way-station is shown, which may or may not be separate from a warehouse/distribution location. In FIG. 2C, a warehouse/distribution location and way station is shown being located as close as possible to a customs/border inspector, so that the beneficial super-freezing effect during storage within the warehouse/distribution way station can assist in overcoming the heat-shock that is associated with the inspection process.

Although not shown in FIGS. 2A-2C, another way of building in more resistance to heat shock would be to have the various products placed directly into their retail containers at the manufacturing site. This has the advantage of increased resistivity to heat shock, as the retail containers would provide an insulating effect. Alternatively, the products could be packaged in larger shipping containers and then loaded into their retail containers at a location in the same country as the retail environment where the product will be sold. As stated, gas- or moisture-barrier plastics may be suitable for this purpose.

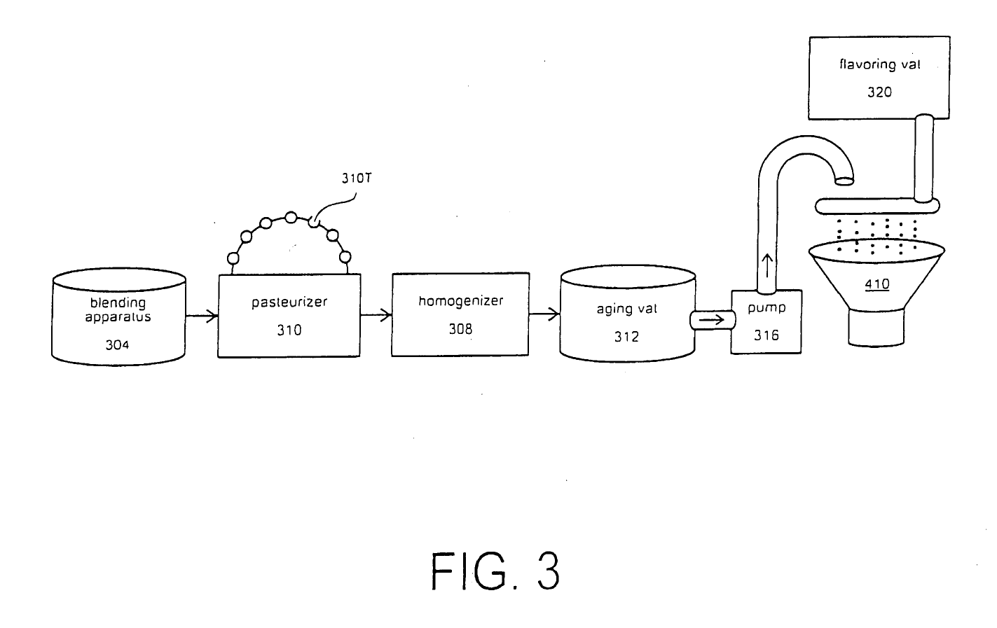

As shown in FIG. 3, a blending apparatus 304 feeds the initial product to a homogenizer 308 that may be used to act as a “timing pump” for the pasteurizer 310, which regulates the speed of the product flowing through the pasteurizer. In some embodiments, the homogenizer 308 is sealed by a government health inspector, and cannot be changed without an inspector present.

The homogenizer 308 and pasteurizer 310 work together as a unit in high temperature short time processes. As shown in FIGS. 1 and 3, the mix is preferably agitated (step 116) right up to the point of pasteurization (step 124), and is then slowly agitated in an aging vat 312 and/or other storage tanks, until being delivered to the cryogenic processor 410. A flavoring vat 320 may optionally be provided to add one or more flavors to the product before it is delivered to the cryogenic processor 410.

Another consideration for production in or for sale in the U.S. is that USDA Pasteurized Milk Ordinances stipulate specific pasteurization temperatures. To address this, as shown in FIG. 3, the length of the holding tubes 310t attached to the pasteurizer 310 determines how long the product will be held at a specific temperature. Different temperatures require different lengths of hold times, and may vary by plant but the minimum temperature and hold time are achieved in preferred embodiments. For 10% butterfat ice cream, for example, the minimum temperature and time is 166° F. for 15 seconds. An 8% fat product needs only to be pasteurized at 161° F. for 15 seconds in one embodiment. For temperatures below 161° F., the minimum is 145° F. for 30 minutes, according to one embodiment. Temperatures and times required may vary by jurisdiction.

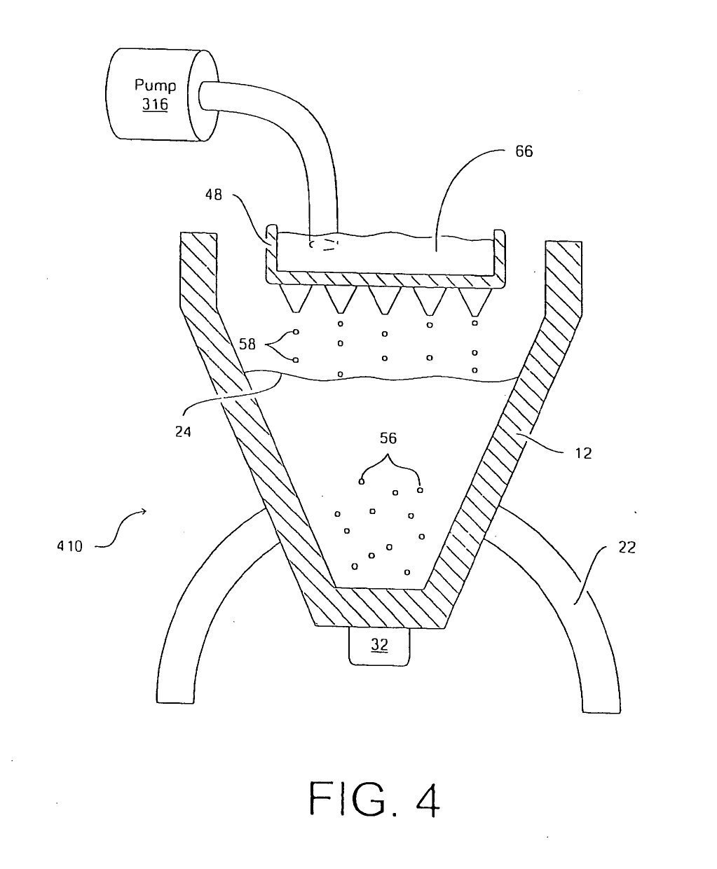

FIG. 4 shows a cross-sectional view of a cryogenic processor 410 constructed in accordance with a preferred embodiment that produces free-flowing particulate shapes 56. The cryogenic processor 410 includes a freezing chamber 12 that is preferably in the form of a conical tank that holds a liquid refrigerant therein. In one embodiment, the freezing chamber 12 is a free-standing unit supported by legs 22.

Refrigerant 24, preferably liquid nitrogen or other cryogenic fluid, is supplied to the freezing chamber 12. A feed tray 48 receives the liquid formulation 66 from a pump 316. The frozen product takes the form of particulate shapes 56 that are formed when droplets 58 of liquid formulation 66 contact the refrigerant vapor and subsequently the liquid refrigerant 24 in the freezing chamber 12. After the particulate shapes 56 are formed, they fall to the bottom of chamber 12. A transport system connects to the bottom of chamber 12 at outlet 32 to auger or carry the particulate shapes 56 to the next part of the process, which may be a package for bulk storage or packaging such as for distribution and/or sale. After having reached the outlet 32, the particulate shapes 56 are free-flowing and do not stick together.

The temperature of the formulation 66 can be maintained at a wide range of temperatures just prior to being dripped into the processor 410 (FIGS. 3, 4). Lower temperatures, preferably around +40° F. or below are preferred so as to promote rapid freezing. The temperature of the formulation 66 preferably does not fall below about 28° F. prior to being dripped so that it does not become too solid to flow well. Higher temperatures will also affect the amount of refrigerant used to freeze the product. A colder mix of formulation 66 uses less refrigerant 24 than a warmer mix, but the particulate shapes 56 of the end product are not substantially affected. In the U.S., the formulation is normally held at about +40° F. due to various Pasteurized Milk Ordinances for minimum temperature storage requirements. These temperatures are often recorded and monitored by USDA inspectors.

The various aspects have been described in detail with particular reference to preferred embodiments, but it will be understood that variations and modifications can be effected within the spirit and scope of the disclosed inventions as described herein. It is anticipated that various changes may be made in the arrangement and operation of the system and formulations without departing from the spirit and scope thereof.

What is claimed is:

1. A composition comprising a plurality of particulate shapes, wherein the plurality of particulate shapes comprise a frozen yogurt food product formed by cryogenically freezing a yogurt-based formulation.

2. The composition of claim 1, wherein the particulate shapes have a diameter of from about 0.05 inch to about 0.5 inch.

3. The composition of claim 1, wherein the yogurt-based formulation comprises an amount of yogurt that is about 0.1% to about 1% of the total weight of the formulation.

4. The composition of claim 1, wherein the yogurt-based formulation has a pH of about 4.0.

5. The composition of claim 1, wherein the yogurt-based formulation has a fat content of about 4% or less.

6. The composition of claim 1, wherein the plurality of particulate shapes are maintained in a free-flowing form when stored at a temperature of about −20° F. to about −40° F.

7. The composition of claim 1, wherein the plurality of particulate shapes are maintained in a free-flowing form when stored at a temperature of about −10° F. and 0° F. with an occasional rise to perhaps as much as +5° F.

8. The composition of claim 1, wherein the yogurt-based formulation comprises about 35.5% or less total solids.

9. The composition of claim 8, wherein the yogurt-based formulation comprises the following ranges of ingredients expressed as a weight percentage of the total: 9-11% milk fat or butterfat; 4-12% non-fat milk solids; and 15-17% sugar.

10. The composition of claim 9, wherein the yogurt-based formulation further comprises a bulking agent of about 20% or less.

11. The composition of claim 9, wherein the yogurt-based formulation further comprises a combined stabilizer/emulsifier of about 1% or less.

12. The composition of claim 1, wherein the yogurt-based formulation comprises about 29.7% or less total solids.

13. The composition of claim 12, wherein the yogurt-based formulation comprises the following ranges of ingredients expressed as a weight percentage of the total: 6-14% milk fat or butterfat; 4-20% non-fat milk solids; and 2.6-8% sugar.

14. The composition of claim 13, wherein the yogurt-based formulation further comprises a bulking agent of about 20% or less.

15. The composition of claim 13, wherein the yogurt-based formulation further comprises a combined stabilizer/emulsifier of about 4% or less.

16. The composition of claim 1, wherein the amount of sucrose is about 4% or less.

17. A method of making a yogurt-based food product, comprising the following steps:
(a) providing a yogurt-based formulation; and
(b) cryogenically freezing the yogurt-based formulation into a plurality of particulate shapes.

18. The method of claim 17, wherein the plurality of particulate shapes formed during step (b) have a diameter of from about 0.05 inch to about 0.5 inch.

19. The method of claim 17, wherein the yogurt-based formulation comprises the following ranges of ingredients expressed as a weight percentage of the total: 9-11% milk fat or butterfat; 4-12% non-fat milk solids; and 15-17% sugar.

20. A smoothie beverage composition comprising a liquid in combination with the plurality of cryogenically frozen particulate shapes of claim 1.

21. The smoothie beverage composition of claim 20, wherein the ratio of the liquid to the plurality of cryogenically frozen particulate shapes by weight is about 1:1.

22. The smoothie beverage composition of claim 21, wherein the ratio of the liquid to the plurality of cryogenically frozen particulate shapes by weight is greater than 1:1.

23. The smoothie beverage composition of claim 21, wherein the ratio of the liquid to the plurality of cryogenically frozen particulate shapes by weight is less than 1:1.

24. The smoothie beverage composition of claim 20, wherein the ratio of the liquid to the plurality of cryogenically frozen particulate shapes by volume is about 1:1.

25. The smoothie beverage composition of claim 24, wherein the ratio of the liquid to the plurality of cryogenically frozen particulate shapes by volume is greater than 1:1.

26. The smoothie beverage composition of claim 24, wherein the ratio of the liquid to the plurality of cryogenically frozen particulate shapes by volume is less than 1:1.

27. A method of making a smoothie beverage comprising the following steps:
(a) providing a plurality of cryogenically frozen particulate shapes made from a yogurt-based formulation; and
(b) combining the plurality of cryogenically frozen particulate shapes with a liquid.
